(19) United States
(12) Patent Application Publication
(10) Pub. No.: US 2025/0074776 A1
(43) Pub. Date: Mar. 6, 2025

(54) METHOD FOR PREPARING ACTIVATED CARBON

(71) Applicants: National Health Research Institutes, Miaoli County (TW); National Taiwan University, Taipei (TW)

(72) Inventors: Feng-Huei LIN, Miaoli County (TW); Chih-Chieh CHEN, Taipei (TW); Chih-Wei LIN, Taipei (TW); Chi-Hsien CHEN, Taipei City (TW); Yue-Liang GUO, Taipei (TW); Ching-Yun CHEN, Miaoli County (TW); Chia-Ting CHANG, Miaoli County (TW); Che-Yung KUAN, Miaoli County (TW); Zhi-Yu CHEN, Miaoli County (TW); I-Hsuan YANG, Taipei (TW)

(21) Appl. No.: 18/460,029

(22) Filed: Sep. 1, 2023

(51) Int. Cl. C01B 32/318; C01B 32/336; C01B 32/366

(52) U.S. Cl. CPC C01B 32/318; C01B 32/336; C01B 32/366

(57) ABSTRACT

The present invention provides a method for preparing an activated carbon, which includes impregnating a carbonaceous material with carbonated water; and exposing the carbonaceous material to microwave radiation to produce the activated carbon.

### BACKGROUND OF THE INVENTION

### Technical Field

The present disclosure relates in general to a method for preparing activated carbon, and in particular, it relates to a method of preparing activated carbon using microwave radiation.

### Description of the Related Art

Air pollution and water pollution are important issues of concern around the world nowadays. Recently, activated carbon has been widely applied for purifying water sources and air due to its excellent adsorption capabilities for heavy metals and volatile organic substances. Activated carbon is produced through carbonization and activation processes using raw materials such as wood, bamboo, animal bones, coal coke, hard fruit pits, and coconut shells. Activated carbon possesses a high specific surface area and high porosity. The porous surface of activated carbon contains numerous functional groups that can be utilized for adsorbing harmful gases, dyes, and chemicals, as well as for purifying drinking water and industrial wastewater.

The preparation method of activated carbon includes carbonizing raw materials to obtain carbonized materials followed by activating them to produce activated carbon. Currently, activation methods include physical and chemical approaches. Physical activation is mainly achieved by using high-temperature steam, with temperatures reaching up to 1200° C. Compared to chemical activation, its advantage lies in lack of strong acid or alkaline solutions during the activation process, making it more environmentally friendly. However, its disadvantages include extremely high activation temperatures, long reaction times, and low yield.

On the other hand, the chemical approach involves the use of strong acid or alkaline to activate the carbon at lower temperatures (400-600° C.) and for a shorter duration. Chemical activation offers the advantage of requiring lower activation temperatures and shorter processing times, resulting in a higher yield compared to physical activation. However, the strong acid or alkaline used during chemical activation makes it less environmentally friendly.

As stated above, both physical and chemical activation have their drawbacks. Given these challenges, the disclosure provides an alternative method for preparing activated carbon.

### SUMMARY OF THE INVENTION

The disclosure provides a method for preparing activated carbon. The method includes impregnating a carbonaceous material with carbonated water and exposing the carbonaceous material to microwave radiation to produce the activated carbon.

In some embodiments, the carbonaceous material includes one or more of pyrolyzed or carbonized material. For example, the carbonaceous material may include charcoal, coal, petroleum coke, tar, char, a residual of thermal treatment of the oil or coal industry, or combinations thereof. In one embodiment, the carbonaceous material includes charcoal.

In some embodiments, the method further includes removing excess carbonated water prior to the step of exposing the carbonaceous material to microwave radiation. The carbonated water is preserved in the carbonaceous material after the step of removing excess carbonated water.

The carbonated water has a pH value between 4.0 to 6.5. In one embodiment, a pH value of the carbonated water is between 4.0 and 6.5, between 4.2 and 6.3, between 4.4 and 6.1, between 4.6 and 5.9, between 4.8 and 5.7, between 5.0 and 5.5, or between 5.2 and 5.3.

Considering the fracturing behavior of coal during milling, the resulting coal particles often exhibit irregular shapes. However, they possess a characteristic body size or maximum side-to-side thickness that enables sub-sieve sized discrete particles to pass through specific sieve meshes. The size of these discrete particles can be described in terms of their spherical diameter, denoted by a U.S. sieve size ranging from 50 mesh to 500 mesh (i.e., 25 μm to 297 μm). This measurement represents the range through which a particle from a charcoal or a slurry sample containing charcoal particles will successfully pass.

In some embodiments, a size of the carbonaceous material is between about 25 μm and about 297 μm.

In one embodiment, a size of the carbonaceous material is between about 30 μm and about 290 μm, between about 35 μm and about 285 μm, between about 40 μm and about 275, between about 45 μm and about 270 μm, between about 50 μm and about 265 μm, between about 55 μm and about 255 μm, between about 60 μm and about 245 μm, between about 70 μm and about 235 μm, between about 80 μm and about 225 μm, between about 90 μm and about 215 μm, between about 100 μm and about 205 μm, between about 110 μm and about 195 μm, or between about 120 μm and about 185 μm.

In some embodiments, the step of exposing the carbonaceous material to microwave radiation is performed under a radiation power of about 100 watts to about 400 watts.

In one embodiment, the step of exposing the carbonaceous material to microwave radiation is performed under a radiation power of about 105 watts to about 390 watts, about 110 watts to about 380 watts, about 120 watts to about 370 watts, about 130 watts to about 360 watts, about 140 watts to about 350 watts, about 150 watts to about 340 watts, about 160 watts to about 330 watts, about 170 watts to about 320 watts, about 180 watts to about 310 watts, about 190 watts to about 300 watts, about 200 watts to about 290 watts, or about 210 watts to about 280 watts.

In some embodiments, the step of exposing the carbonaceous material to microwave radiation is performed for about 5 minutes to about 30 minutes.

In one embodiment, the step of exposing the carbonaceous material to microwave radiation is performed for at least about 25 minutes, at least about 20 minutes, at least about 15 minutes, at least about 10 minutes, or at least 5 minutes.

In some embodiments, a volume ratio of carbon dioxide to water in the carbonated water is about 1.0 to about 10.0.

In one embodiment, a volume ratio of carbon dioxide to water in the carbonated water is about 1.5 to about 9.5, about 2.0 to about 9.0, about 2.5 to about 8.5, about 3.0 to about 8.0, about 3.5 to about 7.5, about 4.0 to about 7.0, about 4.5 to about 6.5, or about 5.0 to about 6.0.

In some embodiments, a volume ratio of the carbonated water to the carbonaceous material is about 5.0 to about 10.0.

In one embodiment, a volume ratio of the carbonated water to the carbonaceous material is about 5.5 to about 9.5, about 6.0 to about 9.0, about 6.5 to about 8.5, about 7.0 to about 8.0.

In some embodiments, the step of impregnating the carbonaceous material is performed for at least 5 minutes.

In some embodiments, the step of impregnating the carbonaceous material is performed under vacuum.

A detailed description is given in the following embodiments with reference to the accompanying drawings.

### BRIEF DESCRIPTION OF DRAWINGS

The disclosure may be more fully understood by reading the subsequent detailed description and examples with references made to the accompanying drawings, wherein:

FIG. 1 shows an analysis of the activated carbon prepared by the method described herein using Raman spectroscopy.

FIG. 2 shows an analysis of the activated carbon prepared by the method described herein using Fourier-transformed infrared spectroscopy.

FIG. 3 shows an analysis of the activated carbon prepared by the method described herein using X-ray diffraction.

FIG. 4 shows a morphological analysis of the activated carbon prepared by the method described herein using Scanning Electron Microscope.

FIG. 5 shows an analysis of the activated carbon prepared by the method described herein using Methylene Blue adsorption test.

### DETAILED DESCRIPTION OF THE INVENTION

The term “about” typically means ±10% of the stated value, more typically means ±5% of the stated value, more typically ±3% of the stated value, more typically ±2% of the stated value, more typically ±1% of the stated value and even more typically ±0.5% of the stated value. The stated value of the present disclosure is an approximate value. When there is no specific description, the stated value includes the meaning of “about.”

The term “carbonaceous materials” used herein refers to a material or substance composed substantially of carbon (e.g., greater than 90%, greater than 95%, greater than 99%, or greater than 99.9% carbon on a weight basis). Moreover, carbonaceous materials described herein may be carbon-containing materials that have not undergone pyrolysis or activation processes to become activated carbon. Examples of the carbonaceous material may include charcoal, coal, petroleum coke, tar, char, a residual of thermal treatment of the oil or coal industry, or any combinations thereof.

The present disclosure introduces a method for preparing activated carbon that utilizes microwave radiation in the presence of weak acid. This approach offers an environmentally friendly alternative to conventional methods, as it eliminates the need for strong acid or alkaline treatments. The activated carbon prepared by the method described herein possess an advantage of high absorbability for impurities dissolved in water and in air.

The conventional activation methods include physical and chemical approaches. The duration of the preparation process in the activation method using physical approach takes about 4 to 12 hours. The long reaction time and high activation temperature causing the physical approach to be energy and time consuming.

On the other hand, the activation method employing the chemical approach has a shorter preparation process duration, ranging from about 2 to 4 hours. However, it is important to note that the chemical approach is considered the least environmentally friendly option due to the use of strong acids and alkalis, which can cause corrosion to the equipment.

In comparison to the conventional activation methods, the activation method described herein employs weak acids, making it more environmentally friendly. Furthermore, the preparation process duration is reduced to less than 1 hour, which is much shorter than the conventional activation methods.

In-depth research was conducted on various parameters including particle size, microwave power level, and microwave heating time to evaluate their influence on the resulting quality of activated carbon. The findings indicate that the microwave-activation method is highly promising due to its short activation time and straightforward process, making it a compelling approach for producing high-quality activated carbon.

### EXAMPLES

Having generally described this disclosure, a further understanding can be obtained by reference to certain specific examples which are provided herein for purposes of illustration only and are not intended to be limiting unless otherwise specified.

### Example 1

### Preparation of Activated Bamboo Charcoal

To prepare activated bamboo charcoal, 30 grams of bamboo charcoal were subjected to cleaning and drying processes before being ground into granules within the range of 50-500 mesh. A suitable quantity of these bamboo charcoal granules was accurately measured and combined with 300 ml of carbonated water in a ratio of 5-10 times the volume. The mixture was then soaked under a vacuum environment for 5 minutes to facilitate the activation process. After removing the excess moisture, various microwave parameter methods were applied to activate the bamboo charcoal, with a power from 100 to 400 W and a duration from 5 to 30 minutes. It was concluded that the optimal parameters for the activation process was 210 W for 10 minutes.

### Example 2

### Identification Analysis Using Raman Spectroscopy

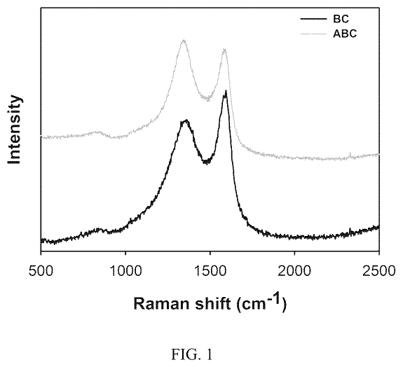

In this experiment, the identification of activated bamboo charcoal was conducted using Raman spectroscopy. The results confirmed that the combination of microwave treatment and carbonated water yielded activated carbon with distinctive Raman features that a D band is more intense than G band. (FIG. 1)

### Example 3

### Identification Analysis Using Fourier-Transformed Infrared Spectroscopy

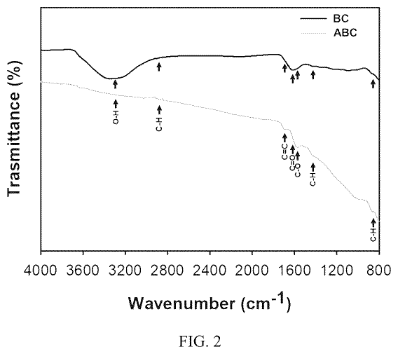

The analysis using Fourier-transform infrared spectroscopy indicated that activated bamboo charcoal possesses a property of containing more functional groups than that of regular bamboo charcoal, which enhances the adsorption of various substances on the activated bamboo charcoal. (FIG. 2)

### Example 4

### Identification Analysis Using X-Ray Diffraction

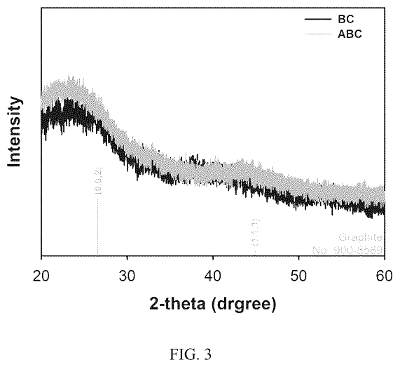

The analysis using X-ray diffraction demonstrated that activated bamboo charcoal also exhibits characteristic peaks that are associated with graphite. (FIG. 3)

### Example 5

### Morphological Analysis Using Scanning Electron Microscope (SEM)

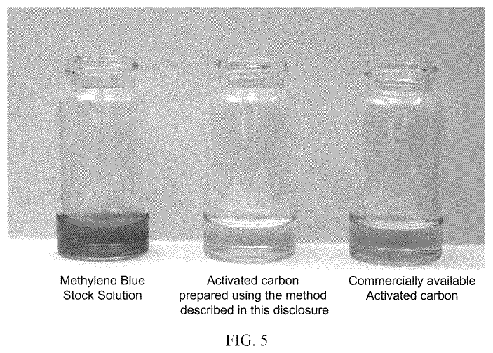

The surface morphology of activated bamboo charcoal was evaluated using a scanning electron microscope (SEM). The results confirmed the presence of numerous pore structures on the surface of activated bamboo charcoal. These structures contribute to a significantly increased surface area, thereby enhancing the rapid adsorption capabilities of activated bamboo charcoal for various substances. (FIG. 4)

### Example 6

### Methylene Blue Adsorption Test

In the methylene blue adsorption test, the activated carbon with a weight of 10 milligrams was exposed to 10 milliliters of methylene blue solution at a concentration of 10 ppm for a duration of 2 minutes. The results demonstrated that the activated carbon prepared using the method in accordance with the embodiments of the disclosure exhibited a superior adsorption efficiency compared to that of the commercially available competitors. (FIG. 5)

Although the foregoing refers to particular preferred embodiments, it will be understood that the present invention is not so limited. It will occur to those of ordinary skill in the art that various modifications may be made to the disclosed embodiments and that such modifications are intended to be within the scope of the present invention, which is defined by the following claims.

All publications and patent applications mentioned in this specification are indicative of the level of skill of those in the art to which the invention pertains. All publications and patent applications are herein incorporated by reference to the same extent as if each individual publication or patent application were specifically and individually indicated to be incorporated by references in its entirety.

1. A method for preparing an activated carbon, comprising:
impregnating a carbonaceous material with carbonated water; and
exposing the carbonaceous material to microwave radiation to produce the activated carbon.

2. The method of claim 1, wherein the carbonaceous material comprises charcoal.

3. The method of claim 1, further comprising removing excess carbonated water prior to the step of exposing the carbonaceous material to microwave radiation, wherein the carbonated water is preserved in the carbonaceous material after the step of removing excess carbonated water.

4. The method of claim 1, wherein a size of the carbonaceous material is between about 25 μm and about 297 μm.

5. The method of claim 1, wherein the step of exposing the carbonaceous material to microwave radiation is performed under a radiation power of about 100 watts to about 400 watts.

6. The method of claim 1, wherein the step of exposing the carbonaceous material to microwave radiation is performed for about 5 minutes to about 30 minutes.

7. The method of claim 1, wherein a volume ratio of carbon dioxide to water in the carbonated water is about 1 to about 10.

8. The method of claim 1, wherein a volume ratio of the carbonated water to the carbonaceous material is about 5 to about 10.

9. The method of claim 1, wherein the step of impregnating the carbonaceous material is performed for at least 5 minutes.

10. The method of claim 1, wherein the step of impregnating the carbonaceous material is performed under vacuum.
